(19) United States
(12) Patent Application Publication
(10) Pub. No.: US 2005/0041948 A1
(43) Pub. Date: Feb. 24, 2005

(54) 3-Point bare fiber gripper

(76) Inventors: Cathal Flanagan, Mission Viejo, CA (US); Kirk Matthes, Fountain Valley, CA (US)

Correspondence Address: IRELL & MANELLA LLP, 840 NEWPORT CENTER DRIVE, SUITE 400, NEWPORT BEACH, CA, 92660, US

(21) Appl. No.: 10/659,463

(22) Filed: Sep. 9, 2003

(51) Int. Cl. G02B 6/00

(52) U.S. Cl. 385/136

(57) ABSTRACT

A gripper that has a pin coupled to a pair of fingers. The gripper is used to grasp and move a fiber optic cable. The pin provides a reference surface that constrains the movement of the cable along a vertical or z-axis relative of the gripper. Constraining the fiber optic cable insures a more repeatable placement of the cable within the gripper. The gripper may include a groove that captures the fiber optic cable and is located along the fingers so that a portion of the fiber optic cable extends below a bottom surface of the gripper fingers. This allows the cable to be in contact with another surface during an assembly process such as soldering to a fiber module substrate.

### BACKGROUND OF THE INVENTION

1. Field of the Invention

The present invention relates to mechanical grippers.

2. Background Information

Automated grippers can be used to pick and move workparts in an industrial process. For example, automatic grippers can be used to grab and move fiber optic cables onto a fiber module. The fiber module contains a photonic device such as a laser diode or a photodetector. The fiber is typically welded to a weld clip, or soldered or glued to a substrate of the module. The assembly station may have a camera that allows for alignment of the fiber optic cable within the module to insure accurate alignment between the fiber and the photonic device.

Automated grippers typically include a pair of fingers that are coupled to an actuator. The finger(s) are moved to grab and release the fiber optic cable. With mechanical grippers of the prior art the fingers may grab the cable at various positions along the vertical or z-axis of the gripper. This variation in vertical position increases the time required to align the cable within the module. It would be desirable to provide a gripper that repeatably provides the same cable location for each fiber optic cable in a mass production assembly process. Prior art grippers may also create undesirable stress in the fiber.

It is preferable to have contact between the fiber optic cable and the module substrate when soldering the cable to the substrate. It would be desirable to provide a gripper that repeatably allows contact between the fiber and a substrate while minimizing stress in the fiber. It is also desirable to provide a gripper with small tips that can reach within small package spaces. It would further be desirable to have a gripper that can be used with a downward looking camera.

### BRIEF SUMMARY OF THE INVENTION

A pin that is coupled to the distal ends of a first finger and a second finger of a gripper. The second finger is coupled to an actuator.

### BRIEF DESCRIPTION OF THE DRAWINGS

FIG. 1 is a front perspective view of a gripper;

FIG. 2 is a sectional view of the gripper;

FIG. 3 is an enlarged view showing a pair of fingers of the gripper in an open position;

FIG. 4 is an enlarged view of the fingers grasping a fiber optic cable;

FIG. 5 is an enlarged view showing the fiber optic cable in contact with a pin of the gripper;

FIG. 6 is an enlarged view showing the fiber optic cable in a V-shaped groove of a finger.

### DETAILED DESCRIPTION

Disclosed is a gripper that has a pin coupled to a pair of fingers. The gripper is used to grasp and move a fiber optic cable. The pin provides a reference surface that constrains the movement of the cable along a vertical or z-axis of the gripper. Constraining the fiber optic cable insures a more repeatable placement of the cable within the gripper. The gripper may include a groove that captures the fiber optic cable and is located along the fingers so that a portion of the fiber extends below a bottom surface of the gripper fingers. This allows the cable to be in contact with another surface during an assembly process such as soldering to a fiber module substrate.

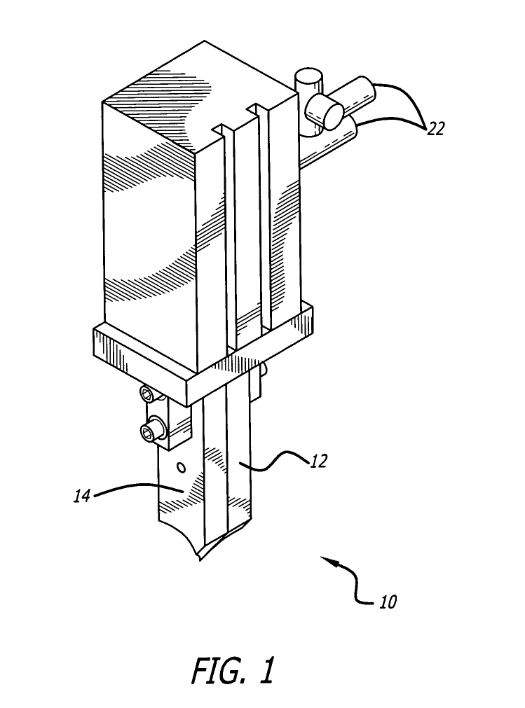

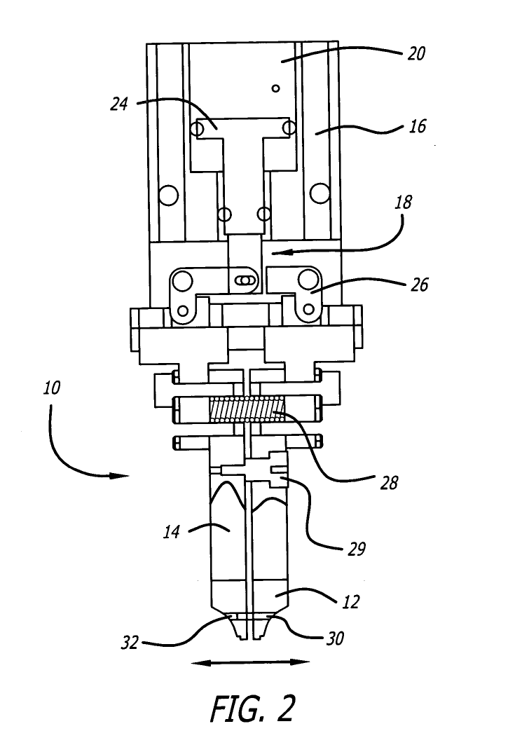

Referring to the drawings more particularly by reference numbers, FIGS. 1 and 2 show an automated gripper 10. The gripper 10 includes a first finger 12 and a second finger 14 that can grasp a fiber optic cable (not shown). The gripper 10 can be coupled to a robotic arm (not shown) or other automated equipment that has one or more degrees of freedom to move the fiber optic cable. By way of example, the gripper 10 may be moved to a tray (not shown) to grasp the fiber optic cable and then moved to a fiber module to align the cable within the module.

The fingers 12 and 14 are coupled to an actuator housing 16. The housing 16 contains an actuator 18 that can move the fingers 12 and 14 in an inward direction and an outward direction. Although movement of the fingers 12 and 14 relative to each other is shown and described, it is to be understood that the first finger 12 may move relative to a stationary second finger 14, or the second finger 14 may move relative to a stationary first finger 12.

The actuator 18 may include a pneumatic cylinder 20 that is coupled to a pair of air lines 22. Alternatively, the gripper 10 may utilize a spring biased actuator that is pneumatically closed and opened by an internal spring (not shown). The cylinder 20 may include a pneumatically actuated piston 24 that is coupled to the fingers 12 and 14 by a scissors mechanism 26. The scissors mechanism 26 translates vertical movement of the piston 24 to a lateral movement of the fingers 12 and 14. Alternatively, the fingers 12 and 14 may move between the open and closed positions along an arc.

The gripper 10 may include a return spring 28 that moves the fingers 12 and 14 in the outward direction to release the fiber optic cable. It is desirable to have a return spring 28 to reduce any backlash during the release process. The gripper 10 may have a stop pin 29 that limits the inward movement of the fingers 12 and 14 prevents crushing of the fiber. The stop 29 also limits the outward movement of the gripper 10 so that the pin 30 stays within finger 14. The fingers 12 and 14 may be constructed from electro-polished stainless steel to minimize any damage to the outer surface of the fiber.

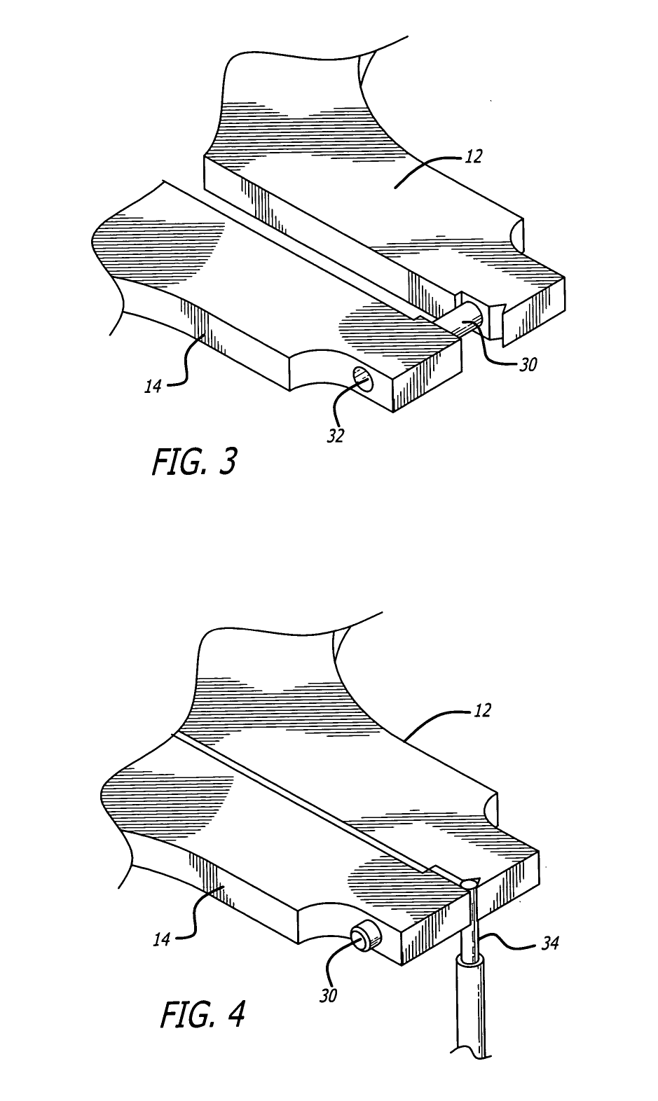

As shown in FIG. 3, the gripper 10 may include a pin 30 coupled to the distal ends of the first 12 and second 14 fingers. The pin 30 may be attached to the first finger 12 and extend through a slip fit aperture 32 in the second finger 14. Conversely, the pin 30 may be attached to the second finger 14 and extend through an aperture in the first finger 12. The actuator 18 may move the fingers 12 and 14 into the open position shown in FIG. 3, the spring 28 providing a biasing force to induce outward finger movement.

As shown in FIG. 4, the actuator 18 moves the second fingers 12 and 14 move inward to grasp a fiber optic cable 34. The gripper 10 and cable 34 can then be moved to a new location such as a fiber module within a solder machine.

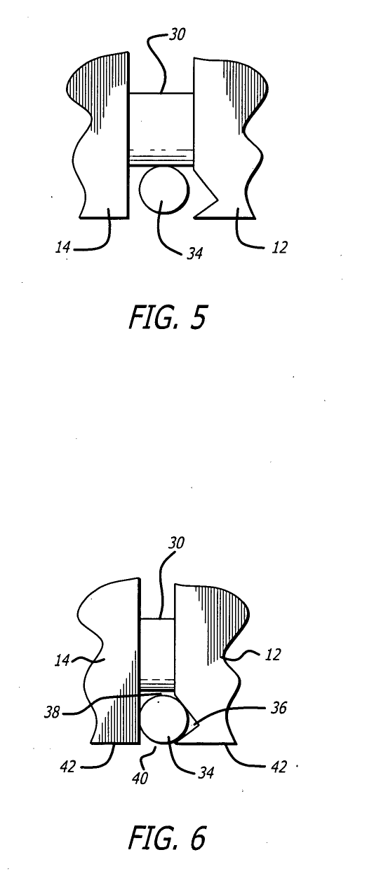

As shown in FIG. 5, when grasping the fiber optic cable 34 the gripper 10 can be initially moved until the cable 34 makes contact with the pin 30. The pin 30 provides a restraint that limits the movement of the cable 34 within the gripper 10 in a vertical direction. This increases the repeatability of the cable 34 location within the gripper 10.

As shown in FIG. 6, moving the fingers 12 and 14 into the closed position may push the cable 34 into a V-shaped groove 36 of the first finger 12. The V-shaped groove 36 prevents movement of the cable 34 within the gripper 10. The gripper 10 may be configured so that there is a gap 38 between the pin 30 and the fiber optic cable 34 when the cable 34 is within the V-shaped groove 36. This insures that the cable 34 will fully seat in the groove 36 without structural interference from the pin 30.

The groove 36 can be located along the first finger 12 so that a portion 40 of the fiber optic cable 26 extends beyond a bottom surface 42 of the fingers 12 and 14. This allows the cable 34 to make contact with another surface (not shown) while still within the gripper 10. For example, it may be desirable to place the fiber optic cable 34 into contact with a module substrate (not shown) and hold the cable 34 in place with the gripper 10 during a solder process.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. An automated gripper for grasping a fiber optic cable, comprising:
a first finger that has a distal end;
a second finger that has a distal end that is separated from said distal end of said first finger by a space;
a pin that is coupled to said distal ends of said first and second fingers and extends across said space to limit a movement of the fiber optic cable between said first and second fingers; and,
an actuator coupled to said second finger.

2. The gripper of claim 1, wherein said first finger has a V-shaped groove.

3. The gripper of claim 1, wherein said pin is attached to said first finger and extends through an aperture in said second finger.

4. The gripper of claim 1, wherein said actuator is coupled to said first finger and moves said first and second fingers in an inward direction and an outward direction.

5. The gripper of claim 2, wherein said V-shaped groove is located along said first finger so that a portion of the fiber optic cable extends below a bottom surface of said first finger and said second finger.

6. The gripper of claim 1, further comprising a return spring coupled to said first and second fingers.

7. The gripper of claim 1, wherein said actuator includes a pneumatic cylinder.

8. An automated gripper for grasping a fiber optic cable, comprising:
a first finger that has a groove and a bottom surface located at an outermost distal location of said first finger, said groove having a location so that a portion of the fiber optic cable extends beyond said bottom surface;
a second finger; and,
an actuator coupled to said second finger.

9. The gripper of claim 8, wherein said groove has a V-shape.

10. The gripper of claim 8, further comprising a pin that is attached to said first finger and extends through an aperture in said second finger.

11. The gripper of claim 8, wherein said actuator is coupled to said first finger and moves said first and second fingers in an inward direction and an outward direction.

12. The gripper of claim 8, further comprising a return spring coupled to said first and second fingers.

13. The gripper of claim 8, wherein said actuator includes a pneumatic cylinder.

14. An automated gripper for grasping a fiber optic cable, comprising:
a first finger that has a bottom surface located at an outermost distal location of said first finger and means for extending a portion of the fiber optic cable beyond said bottom surface;
a second finger; and,
an actuator coupled to said second finger.

15. The gripper of claim 14, wherein said means includes a V-shaped groove.

16. The gripper of claim 14, further comprising a pin that is attached to said first finger and extends through an aperture in said second finger.

17. The gripper of claim 14, wherein said actuator is coupled to said first finger and moves said first and second finger in an inward direction and an outward direction.

18. The gripper of claim 14, further comprising a return spring coupled to said first and second fingers.

19. The gripper of claim 14, wherein said actuator includes a pneumatic cylinder.

20. A method for gripping a fiber optic cable, comprising:
moving a gripper until a fiber optic cable makes contact with a pin that extends between a first finger and a second finger; and,
moving the second finger to grasp the fiber optic cable.

21. The method of claim 20, wherein the fiber optic cable moves into a V-shaped groove of the first finger.

22. The method of claim 20, wherein a portion of the fiber optic cable extends below a bottom surface of the first finger and the second finger.

23. A method for gripping a fiber optic cable, comprising:
actuating a gripper so that a first finger and a second finger of the gripper grasp the fiber optic cable, the grasped fiber optic cable having a portion that extends below a bottom surface of the first finger and the second finger, the bottom surface being located at an outermost distal location of the first finger.

24. The method of claim 23, wherein the fiber optic cable is located within a V-shaped groove of the first finger.
